(19) United States
(12) Patent Application Publication
(10) Pub. No.: US 2026/0210706 A1
(43) Pub. Date: Jul. 23, 2026

(54) Wall Thickness Calculation Using Ultrasound

(71) Applicant: DarkVision Technologies Inc., North Vancouver (CA)

(72) Inventors: Derrell D'Souza, Burnaby (CA); Carlos Alberto da Costa Filho, North Vancouver (CA); Timothy Luu, North Vancouver (CA)

(21) Appl. No.: 19/444,559

(22) Filed: Jan. 9, 2026

(30) Foreign Application Priority Data
Jan. 9, 2025 (GB) 2500222.1

(51) Int. Cl. G01B 17/02; F16L 55/26; F16L 101/30; G01N 29/04

(52) U.S. Cl. CPC G01B 17/02; G01N 29/04; F16L 55/26; F16L 2101/30

(57) ABSTRACT

A device and method for detecting and quantifying wall thickness deviation in cylindrical fluid conduits, such as pipelines and downhole tubing, using ultrasound imaging, is described. The device comprises a probe that emits and receives ultrasound waves, and a processor that performs circle fitting and spline fitting on the ultrasound data to estimate the inner diameter (ID) and outer diameter (OD) of the conduit, and the wall loss due to corrosion or other defects. The method involves transmitting an ultrasound wave along the conduit wall, filtering out the region around the ID and OD reflections, finding the maximum amplitudes in that region, and fitting a spline curve to the ID and OD points. The wall thickness deviation is calculated as the percentage difference between the nominal radius and the radius based on a point on a spline, and an image of the conduit is constructed based on the thickness deviation values.

### FIELD OF THE INVENTION

The current application is directed to the non-destructive testing of objects using ultrasonic tools, and particularly to the quantification of wall thickness of a target using ultrasound.

### BACKGROUND OF THE INVENTION

In the oil and gas industry, fluid-carrying structures such as pipelines and downhole tubing are critical components for the transportation and extraction of fluids. These structures or tubulars may be a well or pipes for carrying hydrocarbons or water, generally having a long, narrow form factor. A well includes cased and uncased wells within a surrounding formation, at any stage from during drilling to completion to production to abandonment. Over time, the integrity of these fluid-carrying structures may deteriorate due to, for example, wear, milling, corrosion, and deformation from physical stress, resulting in wall loss or other defects which can compromise the structural integrity of the structures and lead to leaks or failures. Sand build-up on the walls of metal tubulars and pipelines arises primarily due to the transportation of slurry, which is a mixture of water and finely ground ore or sand. As this slurry moves through the pipelines, the sand particles tend to settle out of suspension, especially in areas where the flow velocity decreases or where there are bends and irregularities in the pipeline. Over time, these settled particles accumulate and adhere to the inner walls of the metal tubulars, forming layers of sand build-up which can lead to reduced flow efficiency, increased pressure drops, and potential blockages. Accurate and efficient detection of structural defects is essential for the safe and reliable operation of these structures.

Conventional methods for detecting wall loss or wall gain due to build-up in pipelines and downhole tubing include visual inspection, magnetic flux leakage, and ultrasonic testing. However, these methods have limitations in terms of accuracy, efficiency, and applicability. For example, visual inspection is time-consuming and may not detect small or hidden defects, while magnetic flux leakage and ultrasonic testing may require complex and expensive equipment and may not be suitable for all types of conduits. Further, conduits and tubing may span hundreds to thousands of meters, and it is generally necessary to inspect fluid-carrying tubulars throughout their entire length.

Certain physical aspects about the tubulars are pre-known or assumed, such as the diameter, section length, connection type, and expected weld connection location and orientation, such as transverse welds and longitudinal welds. Thus, the acoustic imaging tools can be preprogrammed to beam focus at the correct diameter and angles, logging at a rate and resolution that will capture features given the known physical aspects. Identifying localized defects and areas of corrosion of conduits over the full extent of the conduits presents problems for storing acoustic images and processing them. To obtain high resolution images, the transducer array captures a frame every few millimeters. However, at practical memory limits, frame rates and processing speeds, it becomes very difficult to log wells that are many kilometers long.

The inventors have appreciated a need for improved methods and systems for automatically detecting and quantifying wall loss and wall gain in pipelines and downhole tubing that overcomes these limitations.

### SUMMARY OF THE INVENTION

To address the shortcomings of the current tools, a new imaging tool and method are provided to image a target and estimate the parameters for a geometric model of said target, and subsequently determine local variations to calculate the deviation from the geometric model, generally corresponding to a global geometry, to identify any deviation in thickness of the target. Wall loss may occur due to various reasons, including corrosion, pitting, or scale build up, physical deformation due to external forces and loads, and milling of a first, interior surface. Wall gain may occur due to sand build up. The geometry of a target, such as a tubular, is identified by determining the parameters of a first shape model based on imaging data obtained from a first surface of the part. The orientation of a part surface and the normal direction to the surface is determined. A subset of the imaging data is used to determine the parameters of a second shape model. The difference between the surface location according to the first model and the surface location according to the second model along the normal direction is determined, and a thickness deviation factor is estimated, describing wall loss or wall gain. The imaging of the target may include imaging of a second surface, to determine a thickness of the target. The systems and methods as described herein can reliably detect deviation in wall thickness of 10% or more of the nominal target thickness, and can handle various shapes and sizes of tubulars. For beamforming, steered angles or higher mode calculations are not required, and a single velocity can be used for the ultrasound waves. Methods and systems are also disclosed to account for the ovality of the tubular or conduit by performing an ellipse fitting instead of a circle fitting, and can remove the ovality effect from the estimation of wall location.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of inspecting a surface of a target. The method also includes deploying an ultrasound imaging device may include at least one phased array ultrasonic transducer to obtain ultrasound data from a target surface; defining a first region of the ultrasound data based on an estimated location of the target surface within a tolerance of 10% to 90% of a nominal target thickness, in a direction normal to the target surface; identifying a plurality of target surface candidate locations from the ultrasound data within the first region; determining parameter values for a first global shape model defining the target surface from the plurality of target surface candidate locations; determining parameter values for a second shape model defining the target surface from the plurality of target surface candidate locations; generating a thickness deviation factor from a difference between a surface defined by the first global shape model parameter values and a surface defined by the second shape model parameter values, along a direction normal to the surface defined by the first global shape model parameter values; generating a thickness deviation map for the target surface using a plurality of thickness deviation factors; and identifying a flaw based on the thickness deviation map. Other embodiments of this aspect include corresponding computer systems, apparatus, and computer programs recorded on one or more computer storage devices, each configured to perform the actions of the methods.

Implementations may include one or more of the following features. The method where the thickness deviation factor defines a wall loss of the target surface. The second shape model defines a spline function. Generating a thickness deviation factor further may include generating the thickness deviation factor as a percentage of the nominal target thickness. The first global shape model defines a circle. Determining parameter values for the first global shape model further may include using the first subset of candidate locations; where the second shape model is a second global shape model and defines a circle, and where determining parameter values for the second global shape model further may include using the second subset of candidate locations; and where generating a thickness deviation factor further may include determining a non-negative difference between the surface determined by the second global shape model and the surface determined by the first global shape model, along directions normal to the surface determined by the first global shape model. The first global shape model defines an ellipse. Identifying a plurality of target surface candidate locations further may include identifying maximum intensity locations from the ultrasound data, greater than a predetermined threshold. The second shape model is a second local shape model and defines a spline function, and where determining parameter values for the second local shape model further may include determining parameter values for the second local shape model for each of the one or more subsets of adjacent candidate locations. The one or more subsets of adjacent candidate locations are padded with values representing an estimated surface location. Each of the one or more subsets of adjacent candidate locations is obtained from ultrasound data from one of a plurality of phased array ultrasonic transducers. Determining the plurality of target surface candidate locations further may include receiving user input setting one or more of the plurality of target surface candidate locations. Determining the plurality of target surface candidate locations further may include receiving user input modifying one or more of the plurality of target surface candidate locations. Generating a thickness deviation factor further may include generating the thickness deviation factor as a percentage of the measured target thickness. The method may include generating a digital representation of the target using the thickness deviation map and storing the digital representation of the target. Generating a digital representation of the target further may include generating a geometry of the target using the parameter values for a first global shape model and the parameter values for a second shape model. Implementations of the described techniques may include hardware, a method or process, or computer software on a computer-accessible medium.

One general aspect includes a system for inspecting a surface of a target. The system also includes a device with elongate body deployable in a cylindrical fluid conduit, may include one or more outward-facing phased array ultrasonic transducers for emitting plane waves and receiving ultrasound data; at least one processor; and a computer-readable medium storing instructions that, when executed by the at least one processor, cause it to perform the method of any one of claims Other embodiments of this aspect include corresponding computer systems, apparatus, and computer programs recorded on one or more computer storage devices, each configured to perform the actions of the methods.

Implementations may include one or more of the following features. The system where the one or more outward-facing phased array ultrasonic transducers further may include one or more radial arrays. The device further may include a plurality of phased array ultrasonic transducers. The at least one processor further may include at least one cloud processor. Implementations of the described techniques may include hardware, a method or process, or computer software on a computer-accessible medium.

Further aspects of the methods and systems as described herein are set out below and in the appended claims.

### BRIEF DESCRIPTION OF THE DRAWINGS

Various objects, features and advantages will be apparent from the following description of embodiments of the methods, systems and devices as described herein, as illustrated in the accompanying drawings. The drawings are not necessarily to scale, emphasis instead being placed upon illustrating the principles of various embodiments of the methods, systems and devices as described herein.

FIG. 1 is a schematic representation of an imaging device deployed in a pipeline as an inline inspection tool string in accordance with one embodiment as described herein.

FIG. 2 is a lateral view of an imaging device in accordance with one embodiment as described herein.

FIG. 3 is a perspective view of an imaging device in accordance with one embodiment as described herein, including a schematic view of a reference coordinate system.

FIG. 4A is a perspective view showing a tubular with cracks and corrosion.

FIG. 4B is an end view of an imaging tool in a tubular showing alternative planewaves.

FIG. 5A is a schematic view of a transducer array and its imaging field.

FIG. 5B is a schematic view of an acoustic array in an angled arrangement.

FIG. 6 is a block diagram of an imaging device in accordance with one embodiment as described herein.

FIG. 7A is a representation of ultrasound image data showing an intact wall used for determining a thickness deviation factor in accordance with an embodiment as described herein.

FIG. 7B is a representation of ultrasound image data showing wall loss used for determining a thickness deviation factor in accordance with an embodiment as described herein.

FIG. 7C is a representation of ultrasound image data showing wall loss used for determining a thickness deviation factor in accordance with an embodiment as described herein.

FIG. 8 is a flow diagram for carrying out the method in accordance with one embodiment as described herein.

FIG. 9A is a perspective view showing a radial field of view.

FIG. 9B is a schematic diagram showing a first model and a second model, used for determining a thickness deviation factor for a first surface in accordance with an embodiment as described herein.

FIG. 9C is a schematic diagram showing a first model and a second model, used for determining a thickness deviation factor for a second surface in accordance with an embodiment as described herein.

FIG. 10 is a representation of a first model and a second model superimposed on exemplary ultrasound data of a surface, used for determining a thickness deviation factor in accordance with an embodiment as described herein.

FIG. 11 is schematic representation of a thickness deviation factor map in accordance with an embodiment as described herein.

FIG. 12 is a set of ultrasound image data showing a first model and a second model, used for determining a thickness deviation factor in accordance with an embodiment as described herein.

FIG. 13 is a set of images of example targets with flaws.

FIG. 14 shows exemplary representations of a thickness deviation factor map generated in accordance with an embodiment as described herein.

### DETAILED DESCRIPTION OF THE INVENTION

With reference to the accompanying figures, various aspects of the method, system and device as described herein will now be described. For the purposes of illustration, components depicted in the figures are not necessarily drawn to scale. Instead, emphasis is placed on highlighting the various contributions of the components to the functionality of various aspects as described herein. Several possible alternative features are introduced throughout this description and described accordingly. It is to be understood that, according to the knowledge and judgment of persons skilled in the art, such alternative features may be substituted in various combinations to arrive at different embodiments as described herein. For the sake of simplicity and clarity, the same reference numbers have been used in different figures to show similar or corresponding elements throughout the figures and description.

Systems and methods are disclosed for capturing ultrasound reflections from a target by an acoustic imaging tool to determine wall thickness. An acoustic imaging tool generally comprises an imaging device 10 for imaging a fluid-carrying tubular 2 with a circular cross section for carrying fluids such as hydrocarbons, natural gas or water, such as an oilwell casing or pipeline, and having an elongate, cylindrical form factor through which an imaging device 10 can move longitudinally. Pipelines typically include multiple beacons 3, at intervals along the length of the pipeline, with access to a communications network. An operations site 18 deploys the device into the tubular and retrieves data from the imaging device 10. The data is processed and visualized at computer 19, normally remote from the operations site. During its lifetime, the structural integrity of a tubular can become compromised, which can lead to leaks 9 or failures. Metal wall loss in a tubular can result from corrosion 6, pitting 7, cracks 8, and milling, or other forms of mechanical damage such as deformation of some or all the sections of the liner due to mechanical stress through compression, tension, and torsion. To assess the condition and environmental impact of the pipe, a tubular can be assessed to identify such wall loss. Remaining wall thickness, which is the obverse of wall loss, can be used to calculate the burst pressure strength of the tubular.

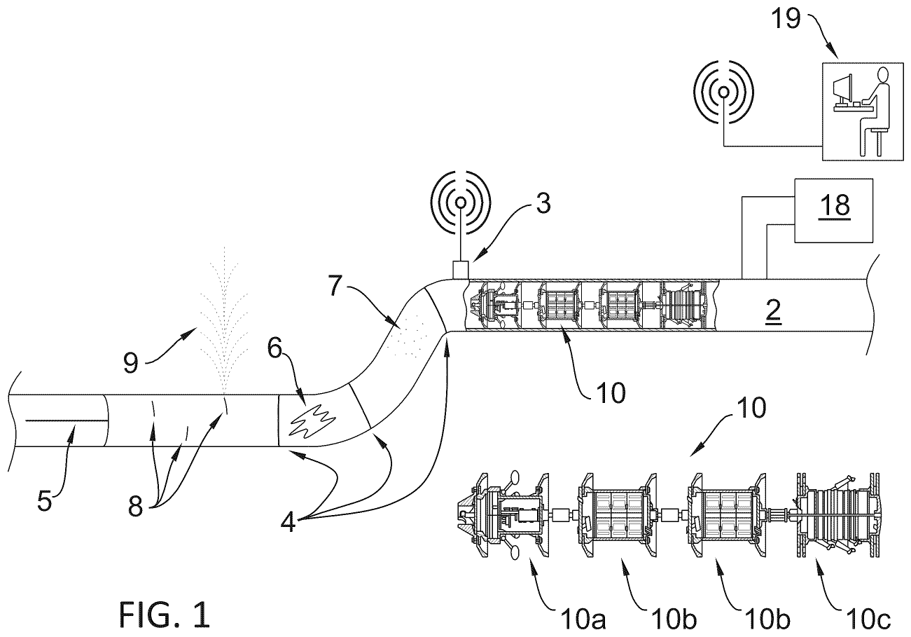

Inline inspection vehicles or inline inspection tools, also known as “smart pigs” or “pigs”, move inside pipelines 2, using a range of sensor technologies to inspect pipelines for defects. Inline inspection tools are designed to navigate the complex geometry of pipelines, including bends, valves, and other fittings, while providing detailed information about the pipeline's condition. The imaging device 10 may be an inline inspection tool string comprising multiple tool string vehicles, as shown in FIG. 1, or operated alone. A tool string may include multiple tool string vehicles, such as one or more sensor vehicles 10a, one or more battery vehicles 10b, and one or more imaging vehicles 10c.

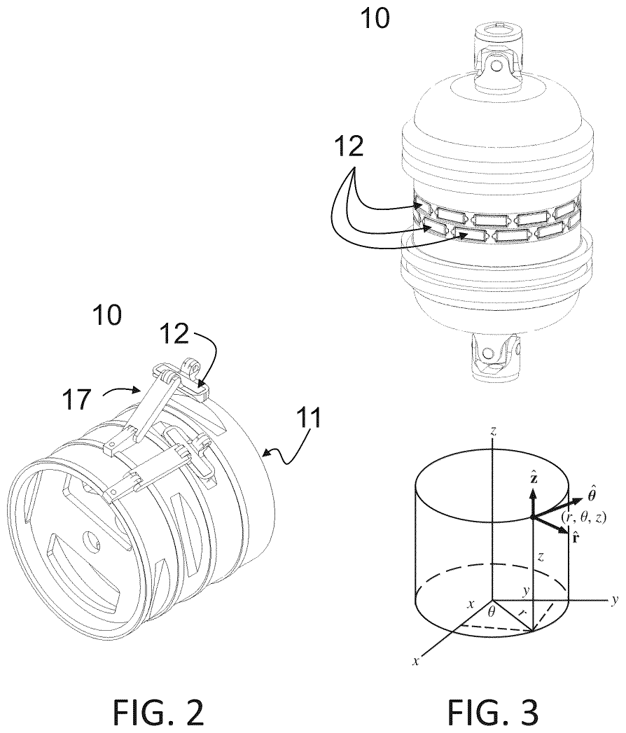

With reference to FIGS. 2 and 3, the tool string vehicles of the imaging device 10 may be a modular inline inspection tool, which is a modular vehicle made up of several swappable, configurable stacked sensor modules 11 that are removably connected to each other, allowing for easy customization and modification for each job. The imaging device 10 typically also has an elongate form factor and is sized to be deployable within the fluid-carrying tubular 2, such as a pipeline or wellbore casing. Each sensor module 11 may comprise one or more transducer arrays 12 mounted with each module, the transducer arrays 12 facing radially outward and typically in a rotationally offset fashion to create a helical arrangement of sensors, and electronics, including an on-board processor for operating the sensors and receiving data from the sensors. Each module provides imaging of a certain section of the pipeline, and multiple imaged sections may be combined to visualize the entire pipeline. The tool may also comprise a separate battery vehicle mechanically and electrically connected to the plural sensor modules, sensor arms, drive cups, centralizer discs, heat sinks thermally coupling the electronics to an exterior of the sensor modules, and a control module. The tool is versatile and can be customized on-site for each job, using different sensors or imaging modes.

For clarity in explaining the present method and system, and with reference to FIG. 3, it is assumed that there is a 3D volume of ultrasound data made up of cross-sectional frames (i.e. in the r-Θ plane) of the tubular, which frames are stacked together and extend longitudinally (z). Thus, each frame is an image in coordinates of azimuth and radius (Θ/r), and stacking frames completes the 3D image by incrementing in the axial (z) dimension. The native units for tubular volume may be cylindrical (r, Θ, z) as shown in FIG. 3. Ultrasound reflections are sampled to capture both positive and negative pressures. The signals are demodulated to create images with pixels of absolute signal energy, for example using a Hilbert Transform. A single frame comprises a plurality of scanlines 50 (Θᵢ) by a plurality of samples (time or radius rᵢ), where the brightness of each pixel represents the reflected energy at that time and scanline. The raw RF data may be stored in memory or deconvolved (e.g. using a Hilbert transform) to store intensity values in memory, using the native polar coordinate (r, Θ, z) of the radial array moving axially in the tubular. Further processing on this data is maintained in polar coordinates to preserve the data and avoid Cartesian approximations.

In operation, a typical data flow includes acquiring cross-sectional frames of the tubular and store them as scanlines, which creates a natively polar coordinate system for a radial array. During subsequent visualization, the stored images are converted to Cartesian coordinates, with neighboring polar pixels combined for each Cartesian pixel, and rendering makes the compiled images of the tubular into an intuitive display. These Cartesian images are loaded into video memory as X, Y, Z pixels (aka voxels). A GPU operates on these Cartesian pixels to create visualization appropriate to a 2D monitor used by operators. The scan conversion from acquired ultrasound images to displayed images can be pre-computed for efficient viewing.

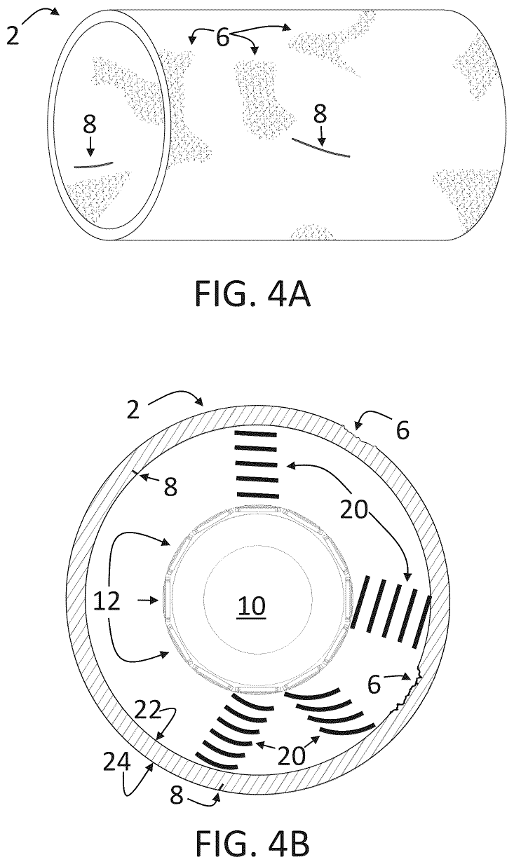

With reference to FIG. 4B, the imaging device 10 comprises one or more transducer arrays 12. In one embodiment, the transducer arrays 12 are formed as an outward-facing radial arrangement that insonify a cross section of the wellbore or tubular 2, from a standoff distance, generating transmitted waves 20 that travel along scanlines 50, towards the inner surface or circumference 22 of the tubular, and a portion of the ultrasound wave continues outwards to the outer surface or circumference 24 of the tubular 2. The transmitted waves 20 may be a plane or curved wavefront, the former having a flat front and the latter having a front that is substantially curved or arc-shaped. Curved/arc-shaped waves can be seen as the polar coordinate equivalent of planar waves. While multiple transmitted waves 20 are illustrated in FIG. 4B, these may be transmitted concurrently or independently. As the imaging device 10 moves longitudinally in the z direction through the tubular 2, the one or more transducer arrays 12 capture frames of these cross sections, preferably on the order of millimeters. The reflections of these acoustic waves from the wellbore or tubular features are converted to digital signals, often called raw RF data. Wellbore or tubular features include pre-known physical aspects of a tubular such as transverse welds 4 and longitudinal welds 5, or features due to wear and deterioration, including corrosion 6, pitting 7, cracks and holes 8, and physical deformation.

Each transducer array 12 may comprise a phased array transducer, each comprising a plurality of acoustic transducer elements 13, preferably operating in the ultrasound band and that can be individually controlled to steer and focus an ultrasonic beam within a material. By manipulating the phase and timing of the pulses sent to each element, a phased transducer array can dynamically adjust the ultrasound beam's direction and focal point, allowing for precise inspection of complex geometries and detection of internal flaws without damaging a target. The frequency of the ultrasound waves generated by the transducer(s) is generally in the range of 200 kHz to 30 MHz, and may be dependent upon several factors, including the fluid types and velocities in the well or pipe and the speed at which the imaging device is moving. The use of a relatively large number of elements generates a fine resolution image of the object. In most uses, the wave frequency is 1 to 10 MHz, which provides reflection from micron features. The transducers may be piezoelectric, such as the ceramic material, PZT (lead zirconate titanate). Such transducers and their operation are well known and commonly available. Circuits 14 to drive and capture these arrays are also commonly available.

The number of individual elements in the transducer array affects the azimuthal resolution of the generated images. Typically, each transducer array is made up of 32 to 2048 elements and preferably 128 to 1024 elements. The logging speed and frame rate determines the axial resolution. An acoustic wave created by one or more of these elements, such that energy is generally focused along a line to form a what is called a scanline. The scanlines are then assembled by the processor to form one frame that approximates one slice of the imaged location. These slices are assembled into a 3D volume in a process called slice stacking.

In an embodiment, transducer elements 13 are arranged as an evenly spaced one-dimensional transducer array 12. In another embodiment, transducer elements 13 are arranged as evenly spaced two-dimensional transducer array. The transducer elements 13 may be distributed radially around the body of the device as a single transducer array 12, or as part of multiple transducer arrays 12, for example, as illustrated in FIGS. 2, 3 and 4B. In such embodiments, the top surface of each of the transducer elements 13 faces radially away from the imaging tool 10 towards the wall of the target or tubular 2. In an embodiment, the transducer elements are distributed around a section of the circumference of the tool housing, and this transducer arrangement captures a cross-sectional slice of the well covering an arc of the tubular. In a further embodiment, the transducer elements are distributed around the totality of the circumference of the tool housing, equidistant around the body of the device. Such a ring-shaped transducer arrangement captures a cross-sectional slice of the well covering 360° around the array 12. As the imaging tool is moved axially in the well or pipe, in either direction, the transducer continually captures slices of the well that are perpendicular to the longitudinal axis of the well. Thousands of these slices are combined to create a 3D visualization of the well.

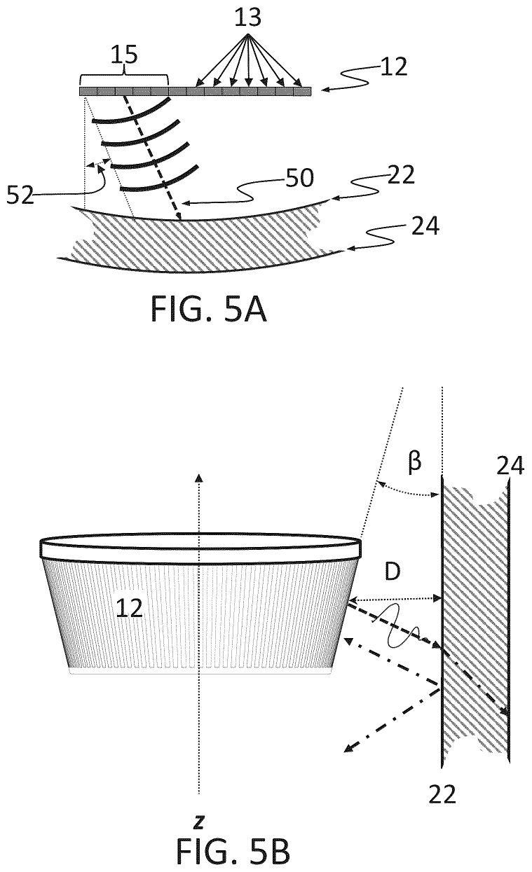

An acoustic transducer element 13 can both transmit and receive sound waves. The shape and size of an array, or limitations of the electronics may mean that each transmit and receive event takes place on less than the full physical array, i.e., an aperture 15. The aperture 15 is a set of neighboring transducer elements that individually contribute towards the constructive wavefront and increase its acoustic energy. The number N of scanlines 50 that make up a full frame may be the same as the number of elements M in the array, but they are not necessarily the same. For example, a 256-element array may operate with a 64-element transmit aperture that slides from one side to the other, capturing many smaller scanlines than if the whole array were pulsed and received at once. The elements in the aperture are selected from the whole array by multiplexors. Normally these are a symmetrical set of elements opposite the part spot to be insonified, i.e. the spot and aperture center have the same azimuthal angle θ. Multiple transducer elements 13, per aperture 15, operate in a phase delayed mode to generate a scanline. There may be as many scanlines 50 as elements by changing the aperture by a single element for each scanline. The apparent origin of the wave can be synthesized within the device, referred to as a transmission point, by the set of transducers, or the aperture 15. In FIG. 5A, scanline 50 appears to radiate out (dashed line) from the center of the five transducer elements 13 in aperture 15. In embodiments, a scanline 50 may be steered at angle 52.

In an embodiment, the one or more transducer arrays 12 are formed as an outward-facing arrangement, on a surface angled to form an oblique-shaped field of view, at an angle β of 10-45°, preferably about 20°, as shown in FIG. 5B. In yet a further embodiment, the one or more transducer arrays 12 are formed as a frustoconical outward facing arrangement, angled to form an oblique-shaped field of view, at an angle β of 10-45°, preferably about 20°. Thus, in these embodiments, the transducer elements are distributed on a surface with transducer elements 13 facing partially in the longitudinal direction of the device. In this arrangement, much of the sound wave reflects further down the tubular, but a small portion backscatters off imperfections on the surfaces or voids within the wall, back towards the transducer, per PCT Application WO 2016/201583 published Dec. 22, 2016 to Darkvision Technologies. FIG. 5B shows acoustic pulses transmitted towards the inner wall, most of which bounces downward (as represented by the dashed lines) and some backwards to the transducer elements 13 (not illustrated). Some of the wave energy propagates to the outer wall, then bounces downward and partially back to the transducer. Note that the angles of the waves and reflected waves in FIGS. 4B, 5A and 5B aren't necessarily shown accurately, but in a manner that allows for the conceptualization of the waves.

The timing of each scan comprises a transmission window Tx, receiving window Rx and dwell period therebetween. As used herein, a scanline 50 is the stream of data received during Rx and may be provided in physical coordinates using the speed of sound. During transmission, the transducers are excited with an electrical pulser, which pulse may be square, sinusoidal or other regular waveform. At the end of Tx there is a dwell period while the wave travel outs and back to the transducer element or aperture. During the Rx window, the circuit ‘listens’ to reflections at the transducer element or aperture. There may be multiple reflections along paths of various lengths, so the Rx window is much wider than the Tx window. The reflections are received at the transducer elements 13. The electrical signals of the reflections may be stored in raw form for later, offline beamforming and image reconstructions. Alternatively, the signals are beamformed in real time and the reconstructed image is stored on the imaging device.

In ultrasound arrays, multiple discreet omnidirectional pulses are emitted from the plural transducer elements 13, which waves interfere constructively and destructively to produce a wavefront moving in the direction of the scanline. As known in the art, altering the timing of the pulse at each transducer element, can steer and focus the wavefront. In steering, the combined wavefront appears to move away in a direction that is not orthogonal from the transducer face, but still in the plane of the array. In focusing, the waves all converge at a chosen distance from the elements 13. The location of the convergence is the focal point and the insonified area defines the resolution of the system. The transmitted wave may or may not be focused at a point on the surface to be imaged. U.S. Pat. No. 5,640,371 provides a method and apparatus for acoustic imaging using beam focusing, beam steering and amplitude shading to increase image resolution and overcome side lobe effects, which may be used in pipelines.

The transmitted wavefront may be described as ‘coherent,’ ‘weakly focused,’ ‘defocused,’ ‘unfocused,’ ‘plane wave’, ‘spherical’, ‘spiral’, ‘divergent,’ or ‘non-convergent’ in as much as the transmitted waves may have some theoretical focal point within or behind the transducer. The transmitted waves may be a plane or curved wavefront, the former having a flat front and the latter having a front that is substantially curved or arc-shaped. Curved/arc-shaped waves can be seen as the polar coordinate equivalent of planar waves. These shapes are created by phase delays of the pulses emitted by each transducer element. Notably, these fronts do not converge or focus on the surface of the target. The transmitted wavefront from the transducer towards a curved target, such as a pipeline or casing, can be an arc, rather than a flat plane wave. Preferably, a curved wavefront hits the inside of a tubular target at the same angle of incidence relative to the normal of the surface of the tubular along the whole area of sonification. The angle of incidence is what defines the overall steering angles for a transmit. This transmit may be computed by ray tracing, knowing the array position relative to the pipe, pipe geometry, speed of sound of fluid, and array geometry.

Receive beamforming is understood by persons skilled in the art of ultrasound. In broad terms, the processor uses plural phases delays, pre-stored in a memory (e.g. look-up-table, or LUT) that convolve/shift the signals based on different focal depths. These signals are combined to reconstruct the final image, whereby weakly focused reflections get diluted and strongly focused reflections are reinforced. As an example, “Delay and Sum” beamforming technique can be used for this purpose.

In conventional imaging, images are formed by beamforming one line at a time. This will drastically reduce the acquisition rate. In order to speed up the beamforming, the same channel data can be used with slightly different delays in order to generate multiple lines, which in preferred embodiments can be extended to generate an entire image slice around the tubular from a single transmit event. This is done by running parallel beamforming on all the scanlines at the same time. This is computationally intensive but allows for much faster image reconstruction.

After areas of the target are captured from plural angles and then receive beamformed to create plural reconstructed images, the step of compounding can be used to combine each of these reconstructed images to create a compounded image using summation of data in the overlapping zone. The summation can be coherent (using RF data) or envelope date (B-mode). The receive beamforming reconstruction will depend on the transmit delays and geometry of the transducer array. The individual angled images are shifted to the same locations, and corresponding pixels in each image are summed to create pixels of the compounded image. The compounded image removes noises that are not coherent in the individual images, reinforces reflectors seen in plural angles, and smooths over glints present in only one of the images.

The imaging device 10 may further comprise an acoustic lens covering an outer surface of one or more of the transducer arrays 12. The acoustic lens may be convex or concave, or may be a concave or convex logarithmic lens having an extended focal zone. The skilled person will appreciate that focusing also depends on the relative speed of sound from the lens material to fluid.

In one embodiment, a convex lens is used. The convex lens is made of a material having an acoustic velocity less than the acoustic velocity of the fluid in the tubular. Typically, well fluid has an acoustic velocity of approximately 1300 to 1700 m/s. A suitable lens material having a lower acoustic velocity is room temperature vulcanization (RTV) silicone, which has an acoustic velocity of approximately 900 to 1050 m/s. With a convex lens, the elevation of the transducer array elements is generally from 5 to 50 mm, depending on the lens curvature and size of the tubular, and preferably 15 mm.

In another embodiment, a concave lens is used. The material of the concave lens preferably has an acoustic impedance close to the fluid in the tubular, and has a higher acoustic velocity than the fluid within the tubular. Suitable materials include hard plastics such as polymethylpentene (PMP) (e.g. TPXTM), polystyrene (PS), and poly(methyl methacrylate) (PMMA). The elevation of the transducer elements is generally from 5 to 50 mm depending on lens curvature and size of the tubular, and preferably 15 mm.

In a further embodiment, a logarithmic lens is used. The logarithmic lens is shaped to create an extended focal zone that can produce sharp images at a range of distances, i.e. images having a high depth of field. Having an extended focal zone is advantageous because a range of depths from inside a tubular to the outside of the casing or liner and everything in between can be imaged with the same tool. An extended focal zone also allows for wells having different diameters to be imaged with the same tool. The logarithmic lens can be concave or convex. A concave logarithmic lens would be made of a material having a higher velocity than the fluid in the tubular, such as polymethylpentene (PMP) (e.g. TPXTM), polystyrene (PS) or poly(methyl methacrylate) (PMMA). A convex logarithmic lens would be made of a material having a lower velocity than the fluid within the tubular, such as RTV silicone. The elevation of the transducer elements is generally from 5 to 50 mm depending on lens curvature and size of the tubular, and preferably 15 mm.

The imaging device 10 may include one or more centralizing elements, such as centralizer discs or other suitable means, for keeping the vehicle centered within the tubular for imaging quality. In the preferred embodiment, the device is concentric with the tubular, i.e. the longitudinal axis of the imaging device 10 is generally aligned with the longitudinal axis of the well or pipeline. Therefore, scanlines radiate perpendicular out from transducer elements 13, arrive focused and perpendicular to the well or pipe surface, and reflect back to transducer elements 13. The times of flight (ToF) for every transmission to the well or pipe are substantially the same, with small variations due to surface imperfections. In an embodiment, the receiving window Rx may be tightly framed around the inner and outer surfaces of the tubular or pipe, i.e. the time for recording reflections is timed to start just before the inner specular reflections and stop just after the outer specular reflections of the emitted ultrasound pulses. However, it is common for the imaging device 10 to be off-center of the tubular (i.e. the longitudinal axes are parallel but not aligned), a condition called eccentricity, resulting in varying times of flight depending on the imaging angle Θ. In other embodiments, the receiving window Rx may be extended to capture reflections from an off-center imaging device, or to capture signals corresponding to additional reflected and resonant signals from other known features of the tubular.

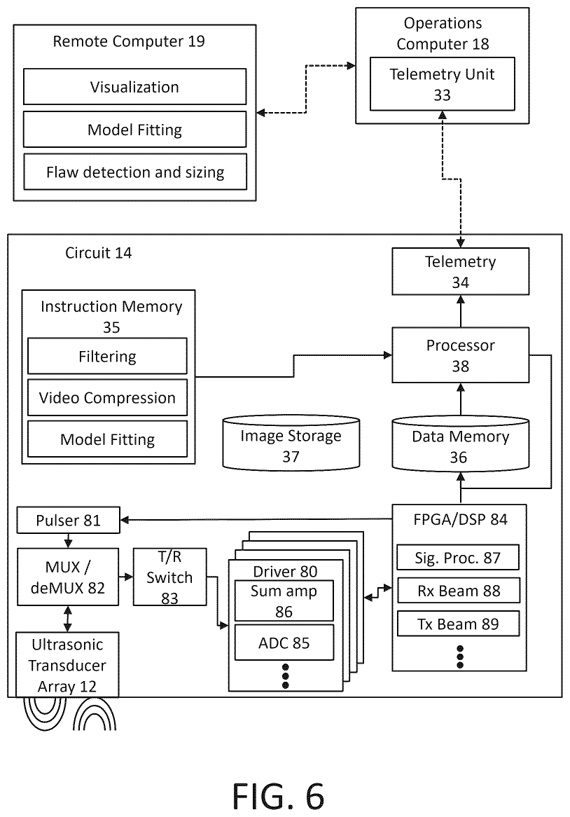

The device comprises a processing circuit for generating and receiving signals from the transducers. The skilled person will appreciate that the circuit may implement logic in various combinations of software, firmware, and hardware that store instructions process data and carry out the instructions. Specialized ultrasound circuits exist to drive and receive arrays of ultrasound transducers, such as LM96511 from Texas Instruments. FIG. 6 is a block diagram of components of the device's on-board circuits 14 and remote computing system 19, including an onboard computer processor 38 (for display and post processing), FPGA block 84, Summing Amps 86, ADC 85, MUX/DEMUX 82, High Voltage T/R switch 83, High Voltage Pulser 81, and timing chips. The FPGA is an efficient chip for integrating many logical operations. The block may comprise Tx beamforming 89 and Rx beamforming 88, DVGA control (Digitally controlled Variable Gain Amplifiers, not shown), as well as data processing operations 87, such as B-mode (brightness mode) and Doppler processing. Although not shown, the circuit may additionally comprise motor drivers and memory chips. By way of example, the transmission step may include selecting the elements 13 in the aperture 15, calculating beamforming timings, loading the pulse timings from the FPGA 84, activating the pulser 81 and MUXes 82 to pulse all elements. The dwell period may be set by the operator based on a nominal diameter of the pipe and speed of sound in the well fluid. The Rx window may be set to capture reflected pulses based on the known, measured or nominal parameters of the target and of the surrounding physical environment. The raw image data is initially stored in memory 36. This may be Terabytes of data. Instructions running on the remote processor include modules for digital receive beamforming, compound processing, wall thickness factor calculation and visualization. Intermediary images, such as a single beamformed image or the compounded image may be stored on the same or separate storage 37. This shows a preferred division of resources for the method described above. However, as computing resources improve, certain processes could be moved onto the device, such as beamforming and compounding. This could also be done during the downtime of the device, when not actively imaging. In this manner, the recovered device is ready to upload fully compounded images to the remote computer for immediate visualization.

Without loss of generality, each of the circuit and electronic components described with reference to FIG. 6 may comprise multiples of such chips, e.g. the memory may be multiple memory chips. For the sake of computing efficiency, several of the functions and operations described separately above may be combined and integrated within a chip. Conversely certain functions described above may be provided by multiple chips, operating in parallel. For example, the LM96511 chip operates eight transducers, so four LM96511 chips are used to operate an aperture of 32 transducers.

It will be appreciated that data processing may be performed with plural processors: on the device, at the operations site, and optionally on a remote computer. The term ‘processor’ is intended to include computer processors, cloud processors, microcontrollers, firmware, GPUs, FPGAs, and electrical circuits that manipulate analogue or digital signals. While it can be convenient to process data as described herein, using software on a general computer, many of the steps could be implemented with purpose-built circuits.

It will be appreciated that the various memories discussed may be implemented as one or more memory units. Non-volatile memory is used to store the compressed data and instructions so that the device can function without continuous power. Volatile memory (RAM and cache) may be used to temporarily hold raw data and intermediate computations. Additionally or alternatively, the compressed images may be transmitted over a telemetry unit of the device to a corresponding telemetry unit of the surface computer system.

After the ultrasound data has been filtered and corrected, it may be rendered for display. A rendering engine may reside in software or on a GPU and has numerous standard rendering algorithms to output a visually pleasing 2D image. The reflection signals may be displayed to a user in their raw signal form, whereby the 2D image is created from pixels separated by the signal's Time of Flight, and wherein pixel brightness is proportional to signal strength. Known rendering engines normally operates on pixels provided in Cartesian space, so a Cartesian voxel to display will be fetched from several polar coordinate voxels, LUT corrected, combined and then scan converted to Cartesian.

In an embodiment, a radial transducer array 12 creates an image frame by imaging an entire 360° cross-section of the target 2. In physical memory, the frame is stored “unwrapped.” Thus, although a frame for a radial array stores scanlines in order from 0 to 360° in memory, the two ends are in fact neighbours in the real-world tubular. Thus, algorithms that slide across multiple neighbouring scanlines should also wrap around the end scanlines.

In addition to standard rendering options such as ray marching, texturing, and lighting, application-specific rendering may be applied to convey surface roughness, material reflectivity, attenuation, impedance and tubular defects. While some of these effects have no analogue in camera imaging, they highlight features detectable by ultrasound waves, especially those relevant to tubular structural integrity. For example, a small crack that is invisible to cameras may create a ringing ultrasound wave that can be displayed in a differentiating way on the monitor.

With further processing, a geometric model of the target or tubular may be created. Using edge detection and surface finding techniques, the processor can create a mesh of the tubular for analysis. Such analysis may include measuring diameter, lengths, connections or identifying damage and perforations.

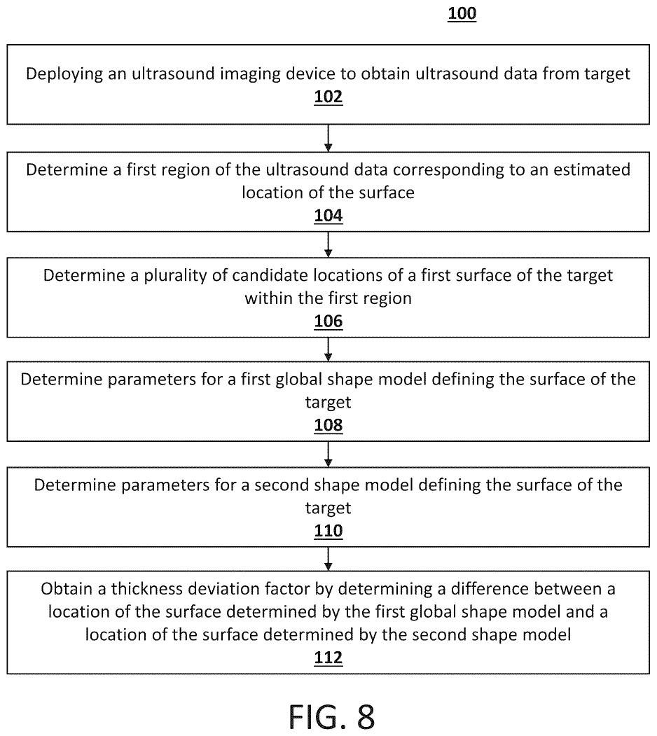

In operation, an inline inspection tool travels along the interior of a pipe or tubular in the longitudinal direction capturing ultrasound images of a first surface of the tubular. In embodiments, ultrasound images of a second surface of the tubular are obtained. The process involves transmitting a polar wave along the tubular wall and filtering the data to exclude the region outside a region of interest. A plurality of candidate locations in the region of interest are then found, and a shape model, such as a circle, is fitted to the candidate locations, for example, using K-means. This model fitting technique for a circle uses the nominal radius, and only the X center and Z center of the circle change. A normal direction to the surface is determined. One or more subsets of the points within the region of interest are fit to a second model, such as a spline, to obtain a localized model of the surface. Without loss of generality, the term shape as used herein refers to the form of a feature or multiple features, including information about the location, scale and orientation, as represented in ultrasound data and images. The difference between the radius from the circle model and the distance from the circle center to the spline, in the normal direction to the surface, is used to determine a thickness deviation factor. Wall gain due to, for example, scale build up on a surface of the target can also be quantified using the devices and methods described herein. Without loss of generality, the thickness deviation factor as used herein can represent both wall loss and wall gain. In an embodiment, the sign of the thickness deviation factor distinguishes between wall loss and wall gain, for example, a negative factor value can describe wall loss while a positive factor value can describe wall gain. A value for thickness deviation may be determined as an absolute value described in millimeters or inches, or as a percentage of the target thickness, determined from, for example, a nominal target wall thickness or a measured wall thickness. An image of the tubular is then constructed based on the thickness deviation values. The technique can also account for the ovality of the conduit by performing an ellipse fitting instead of a circle fitting, and can remove the ovality effect from the thickness deviation estimation. FIG. 8 is a flowchart of an example process 100. In some implementations, one or more process blocks of FIG. 8 may be performed by a device.

K-means is a widely-used clustering algorithm that partitions a dataset into K distinct, non-overlapping subsets or clusters. The goal is to minimize the within-cluster variance, meaning that the algorithm tries to make the data points in each cluster as similar as possible. It does this by iteratively assigning data points to the nearest cluster centroid, which is the average of the points in the cluster, and then recalculating the centroids. This process repeats until the centroids stabilize, and the assignment of data points to clusters no longer changes. K-means is particularly useful for its simplicity and efficiency in processing large datasets, making it a popular choice for data segmentation, pattern recognition, and image compression tasks.

Fitting points to a spline function is a process that involves creating a smooth curve through a set of data points. This technique is used in various fields such as computer graphics, data interpolation, and geometric modeling. The process begins with defining a set of control points, which the spline will pass through or near. A mathematical function, typically a polynomial or piecewise-polynomial, is then constructed to create a curve that smoothly transitions between these points. The spline can be adjusted by altering the control points, changing the degree of the polynomial, or modifying other parameters to achieve the desired shape and smoothness. This method is particularly useful for modeling complex shapes and creating smooth transitions in a controlled manner.

As shown in FIG. 8, process 100 may include deploying an ultrasound imaging device to obtain ultrasound data from the target (block 102). For example, the device may be deployed in a tubular and moved therethrough by wireline when downhole, or by launcher and pumped in a pipeline. Ultrasound data is obtained by transmitting (unfocussed) acoustic waves toward the tubular from one or more of the ultrasound elements 13 of the ultrasound transducer array 12. The ultrasound transducer array 12 then receives reflections from the target to create the ultrasound data, which is stored in on-board memory. As also shown in FIG. 8, process 100 may include determining a first region of the ultrasound data (block 104). As further shown in FIG. 8, process 100 may include determining a plurality of candidate locations of the surface of the target from the ultrasound data within the first region (block 106). As also shown in FIG. 8, process 100 may include determining parameter values for a first global shape model defining the surface of the target, from the plurality of candidate locations (block 108). As also shown in FIG. 8, process 100 may include determining parameter values for a second shape model defining the surface of the target, from one or more of the plurality of candidate locations (block 110). As further shown in FIG. 8, process 100 may include obtaining a thickness deviation factor by determining a difference between a location of the surface determined by the first global shape model and a location of the surface determined by the second shape model (block 112).

Although FIG. 8 shows example blocks of process 100, in some implementations, process 100 may include additional blocks, fewer blocks, different blocks, or differently arranged blocks than those depicted in FIG. 8. Additionally, or alternatively, two or more of the blocks of process 100 may be performed in parallel.

In one embodiment, the imaging device 10 is used to image a portion of a tubular 2, by insonating an area of interest with ultrasound pulses emitted by the transducer array 12 to obtain a plurality of scanlines. Preferably, the imaging device 10 is centered within the tubular 2, and the transducer array 12 receives ultrasound echoes from the insonated area, and generally corresponding to a first surface or inner diameter of the tubular, proximal to the transducer array 12. Reflected ultrasound waves may also be received from a second boundary, distal to the first boundary with respect to the transducer array, and generally corresponding to a second surface or outer diameter of the tubular.

Optionally, a first alignment step may be performed on the ultrasound data, when deviation from a preferred alignment between the transducer and the insonated target is identified. In this context, a preferred alignment refers to when the ultrasound transducer lies generally equidistant from the surface of the target being imaged. In one embodiment, a preferred alignment of a radial transducer within a tubular with a generally circular cross section corresponds to the radial transducer being centered within the conduit and imaging the inner surface of the conduit in a generally radial direction. In another embodiment, a preferred alignment of a linear transducer imaging a generally flat target corresponds to the linear transducer aligned to be parallel to the surface of the part, with a constant standoff between the transducer array and the surface. Deviation from a preferred alignment can be determined by various means, including sensor measurements, image processing, or manual identification, among others. Upon identification of deviation from a preferred alignment, the ultrasound data may be further re-sampled, rotated, translated, scaled, or otherwise processed using known methods, so that the deviation from the preferred alignment is minimized.

The nominal dimensions of an imaged tubular, including an inner radius, an outer radius, and wall thickness, are generally known. Given the known nominal values, a region of interest is determined for the ultrasound data, corresponding to a region including the estimated location of a surface of interest. In embodiments, the estimated location of a surface of interest is calculated using nominal values and known geometry of the target. In embodiments, the estimated location of a surface of interest is calculated using sensor measurements and known geometry of the target. In embodiments, the estimated location of a surface of interest is entered as a user input, or provided as a user selection. In embodiments, the estimated location of a surface of interest is determined using a machine learning algorithm.

In an embodiment, the region of interest is determined as the estimated location of the surface of interest, or the estimated distance between the transducer array and the surface of interest, plus an additional offset. In an embodiment, the additional offset is determined as a percentage of the nominal thickness or width of the target or part, including 10%, 20%, 30%, 40%, 50%, 60%, 70%, 80%, or 90% of the thickness of the target. In one embodiment, where the nominal thickness of a tubular is 9 mm and the standoff is 20 mm, the offset is about +−20% of the thickness of the part, or +−2 mm, resulting in a region of interest, in the scanline direction, being about 40% of the thickness of the part, centered at the estimated location of the surface of interest of the target, or from about 18 mm to about 22 mm. In a further embodiment, the offset is about +−10% of the thickness of the part, or +−1 mm, or from about 19 mm to about 21 mm. In a further embodiment, the region of interest is not centered at the estimated location of the surface of interest, but rather selected to include reflections from a surface of interest and to exclude reflections from other surfaces. For example, for a tubular with a nominal wall thickness of 9 mm, with a distance from the transducer array to the target, or standoff, of 20 mm, where the surface of interest is the inner diameter, an exemplary region of interest is set from 19 mm to 28 mm. In a further example, for a tubular with a nominal wall thickness of 9 mm, with a distance from the transducer array to the target, or standoff, of 20 mm, where the surface of interest is the outer diameter, an exemplary region of interest is set from 21 mm to 30 mm. In a further embodiment, a region of interest is established by setting parameters for a receiving window Rx using the calculated offsets, i.e. the time for recording reflections is timed to start and stop to receive the reflections of the emitted ultrasound pulses within the region of interest. By selecting a region of interest, the image data corresponding to the surface of interest is retained, and image data corresponding to other features, such as that from another surface, or noise and higher order reflections, are excluded from consideration. The ultrasound data is filtered so that only the data in the region of interest is processed in the subsequent steps.

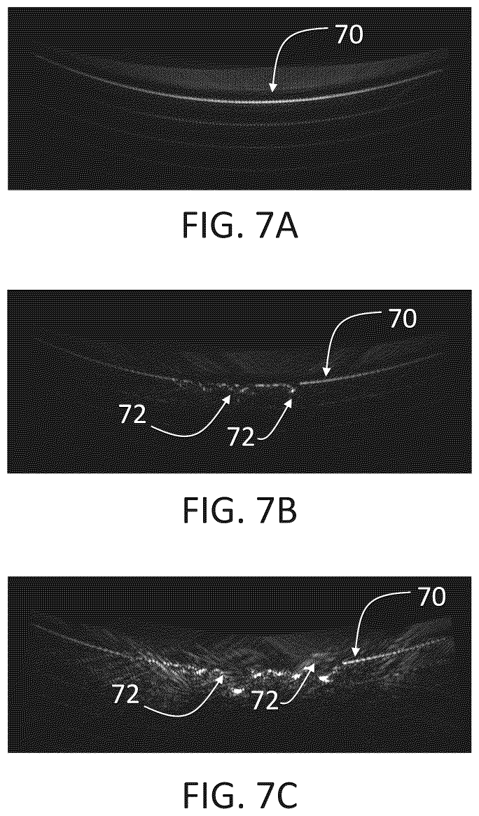

With reference to FIG. 7A, an exemplary ultrasound image frame of an inner diameter surface 70 is shown, for a tubular without significant defects. With reference to FIGS. 7B and 7C, exemplary ultrasound image frames of an inner diameter surfaces 70 are shown for a tubular with corrosion defects 72.

A plurality of candidate locations determined from the ultrasound data in the region of interest are used to calculate the parameter values of a first or global model representing a global shape of a surface of the target. In an embodiment, a reference grid comprising rows and columns is associated with the ultrasound data and at least one candidate location is determined for each of the rows or columns. Depending on the reference frame of the data, rows and columns are generally associated with radial distance and angle, or to the ordinate and abscissa of a Cartesian representation. In an embodiment, all candidate locations are used to calculate the parameter values of a first model. In an embodiment, the surface of interest corresponds to a first surface of the target. In an embodiment, the first surface of the target corresponds to the inner diameter, or ID, of a tubular. In a further embodiment, the surface of interest corresponds to a second surface of the target. In an embodiment, the second surface of the target corresponds to the outer diameter, or OD, of a tubular. Generally, any model that accurately represents the global shape or contour of the surface of interest being imaged, or the section of the surface of interest being imaged, can be used. In one embodiment, the first model is a circle. In another embodiment, the first model is an ellipse. In yet a further embodiment, the first model is a curve. In yet a further embodiment, the first model is a curve representing a complex surface. In another exemplary embodiment, the first model is a line. It is advantageous to use shape models with few parameters, as this generally provides a smooth and global description of the surface.

The ultrasound data in the region of interest is processed using known methods, such as identifying the maximum pixel intensity, the maximum pixel intensity greater than a predetermined threshold, calculating an average of the pixel intensity over a predetermined window, or other suitable methods, to determine a plurality of candidate locations of the first surface of the target part. In embodiments, when a suitable candidate location is not available, for example, because the maximum pixel intensity within the region of interest is below a predetermined threshold, or when a candidate location is not available for a given row or column of an associated reference grid, input may be received from a user to set the candidate wall location. In further embodiments, the plurality of candidate locations can be modified based on input received from a user. The plurality of candidate locations are used to estimate the parameter values for the first model. In a preferred embodiment, model parameters are determined using a K-means cluster algorithm using a plurality of pixels with maximum pixel intensity, where each pixel intensity is greater than a predetermined threshold.

In an embodiment, a tubular with a generally circular cross section is imaged by an imaging device 10 with a steerable probe at an angle about a known axis Z offset from the transverse plane of the conduit, where both the angle and the axis are known. The nominal radius of the tubular and the location of the probe within the tubular are also known. This information is used to calculate the region of interest within the image. The parameter values of the first model are determined based on the ultrasound image data within a first region of interest, to fit the data to a circle. The detected circle from the model parameters is then rotated about the known axis Z to calculate the circle parameters of the cross section.

After the parameter values for the first model have been determined, one or more of the plurality of candidate locations are used to estimate parameter values for a second model representing a local shape of the surface of the target. In embodiments, the region of interest is updated and determined as described above, using the location of the surface determined by the first global shape model to calculate the estimated location of the surface of interest, and a new plurality of candidate locations determined from the ultrasound data in the updated region of interest prior to estimating parameter values for the second model. In an embodiment, all of the plurality of candidate locations are used to determine the parameters of the second model. In further embodiments, the plurality of candidate locations are subdivided into multiple subsets of candidate locations, and parameters for multiple instances of the second model representing a local shape of the surface of the target are determined for each subset of candidate locations. In embodiments, each of the multiple subsets of candidate locations comprise adjacent or generally adjacent candidate locations, corresponding to image data from a localized area of the imaged wall surface. In embodiments, when a suitable candidate location is not available, for example, because the maximum pixel intensity within the region of interest is below a predetermined threshold or when a candidate location is not available for a given row or column of an associated reference grid, the candidate location can be padded or set as the estimated location of the wall surface of the target using the estimated parameter values for the first model. In embodiments, when a suitable candidate location is not available, input may be received from a user to set the candidate wall location. In further embodiments, the plurality of candidate locations can be modified based on input received from a user. In yet further embodiments, the edges of each of the multiple subsets can be padded with a predetermined value corresponding to the location of the estimated surface, such as one of a constant or the estimated location of the wall surface of the target using the estimated parameter values for the first model. In a further embodiment, when a candidate location is not available for a given row or column of an associated reference grid for one or more of the multiple subsets, the missing candidate locations are padded with a predetermined value, such as one of a constant or the estimated location of the wall surface of the target using the estimated parameter values for the first model, such that there is a connected path of candidate locations for each associated reference grid. For example, a connected path comprises at least one candidate location for each of all rows or all columns of a reference grid. In this context, padding each of the multiple subsets is equivalent to adding additional candidate locations to each subset.

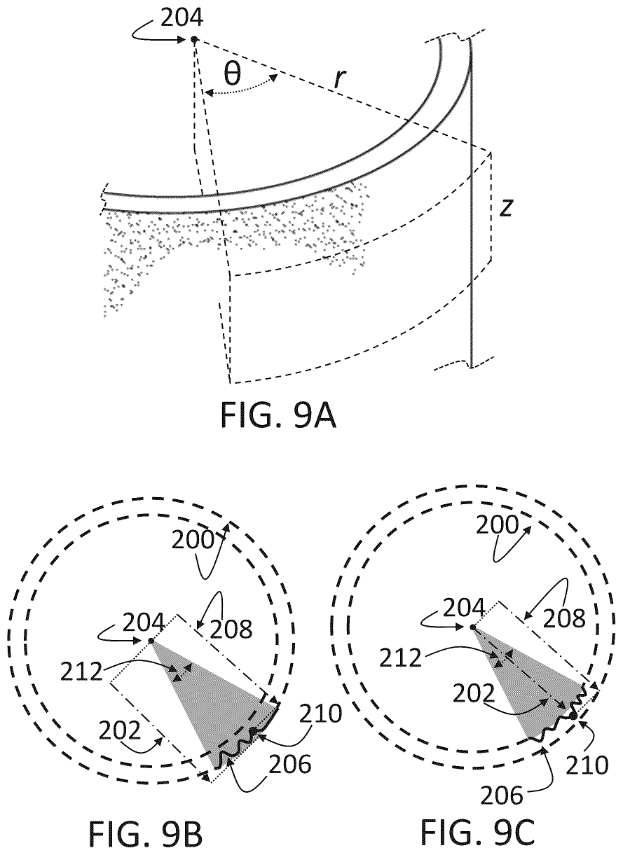

In embodiments where the tubular 2 has a generally circular cross section and the imaging tool 10 comprises multiple transducer arrays 12, as illustrated in FIG. 4B, the plurality of candidate locations are subdivided into arcs, spanning a given angle φ, as shown, for example, by 212 in FIGS. 9B and 9C, each arc corresponding to a field of view of each transducer array 12, and where each arc includes image data for a section of the imaged surface of the target. Parameter values for each one of the one or more instances of the second model is determined using the candidate location data within each corresponding arc. For each subset of candidate locations, the total angle of the arc is determined from the field of view for a frame for a given transducer array 12 imaging a section of the target surface, and is represented as an angle offset from the central scanline of the frame. In other words, parameter values for each instance of a second model are estimated from the candidate locations for each frame obtained from each of the multiple transducer arrays 12 of an imaging tool 10, each capturing ultrasound data for sections of the imaged target surface. In one embodiment, the angle offset is +−30 degrees, for a total arc of 60 degrees. In a further embodiment, the angle offset is +−16 degrees, for a total arc of 32 degrees. In yet a further embodiment, the angle offset is set to +−10 degrees, for a total arc of 20 degrees.

In further embodiments, where the tubular 2 has a generally circular cross section, the plurality of candidate locations may be subdivided into arcs, where a total arc is selected such that a typical area of corrosion is imaged in its entirety within the arc. Larger arcs, for example spanning more than 60 degrees, will typically include surface areas without corrosion which will tend to match the first model, and will increase computation and processing time without providing additional significant information. Smaller arcs, for example, spanning less than 20 degrees, will typically not span an entire corrosion feature.

In an embodiment, the candidate locations within each of the plurality of subsets are fit to a spline function using least squares, and parameter values for the second model are determined. Suitable candidate locations are determined, such as identifying maximum intensity along the image line within the region interest, identifying the maximum intensity along the image line higher than a predetermined threshold within the region of interest, or selecting other appropriate candidate locations. If a suitable candidate location is not available, the suitable candidate location data can be padded using an estimate, such as one obtained from the parameters fit to the first model, data from adjacent candidate locations, or using data from another suitable approximation. The use of splines as a model is advantageous as they provide smooth interpolation between data points and can handle missing data effectively, while still accurately matching surfaces for which data is available.

In an embodiment, a second region of interest is determined, corresponding to a region including the estimated location of a second surface of the imaged target. In embodiments, the estimated location of the second surface of interest is calculated using nominal values and known geometry of the target. In embodiments, the estimated location of a surface of interest is calculated using sensor measurements and known geometry of the target. In embodiments, the estimated location of the second surface of interest is entered as a user input, or provided as a user selection. In embodiments, the estimated location of the second surface of interest is determined using a machine learning algorithm. In one embodiment, when imaging a tubular 2 with a circular cross-section, the second region of interest is determined as the estimated location of the outer diameter of the tubular, or the estimated distance between the transducer array and the outer diameter, offset by a percentage of the thickness of the part. In a further embodiment, a second region of interest is established by setting parameters for a receiving window Rx using the calculated offsets such that reflections for a second surface are acquired, as described above with respect to the first surface. The ultrasound data in the second region of interest is used to determine the parameters of a third model to estimate the location of a second surface, as described above with respect to the first model. In a preferred embodiment, the third model is a curve representing a complex surface.

In an embodiment, the thickness of the imaged part or tubular 2 is the nominal part thickness, determined by inspection or given as a known value. In a further embodiment, the thickness of the part is calculated from the estimated locations of the first surface and second surface, from the estimated parameters for the first model and the third model, respectively.

In an embodiment, a user may modify, add or delete candidate locations used to determine the parameters for any of the first model, the one or more instances of the second model, and for the third model. A user may select an existing candidate location and remove that candidate location from being considered to determine the parameters of any of the first model, second model or third model. A user may select an existing candidate location and modify the position of the candidate location in the direction normal to the first surface and/or second surface of the part. In an embodiment, when no candidate location data is available for a location, a user may add a candidate location to be used to determine the parameters for a first model or second model. In an embodiment, the user may modify, add or delete candidate locations using a graphical user interface which can comprise a representation of the ultrasound data, a representation of one or more regions of interest, a representation of the candidate locations, and a representation of the first model, the one or more instances of the second model, and/or the third model. In a further embodiment, the representations of the first model, of the one or more instances of the second model, and/or the third model are updated in real-time as a user modifies, adds or deletes candidates points.

A normal direction to the first surface is determined to calculate a thickness deviation factor at a specific location. The surface normal direction can be determined from the known geometry of the imaged part and transducer, by calculation from the first model fit to image data, by a combination of the known geometry and the first model, or by other suitable methods. For each location, the wall loss or gain is calculated as the difference, in the direction normal to the first surface, between the distance from a reference location and the first surface, as determined by the first model, and the distance between the reference location and the first surface, as determined by a corresponding instance of the second model. In an embodiment, the estimated wall loss or gain is scaled by the inverse of the thickness of the target at that location, to determine a factor that indicates the thickness deviation due to wall loss or wall gain as a percentage of the thickness of the target or part.

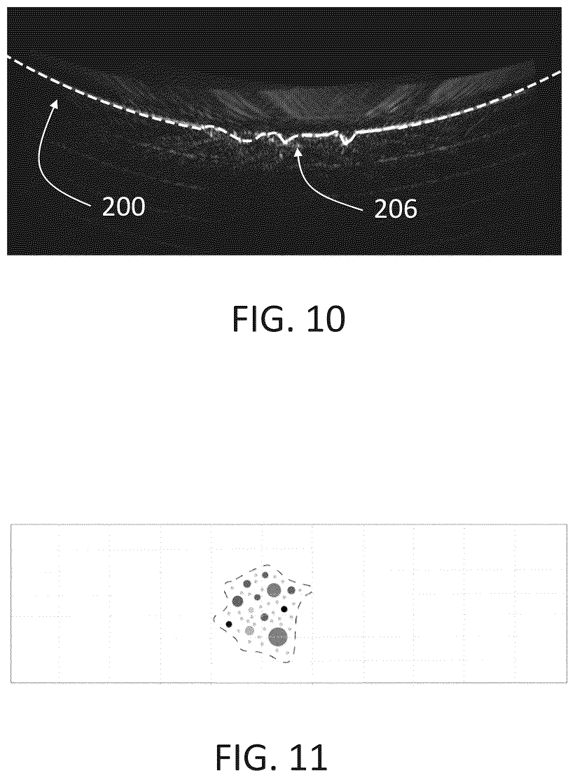

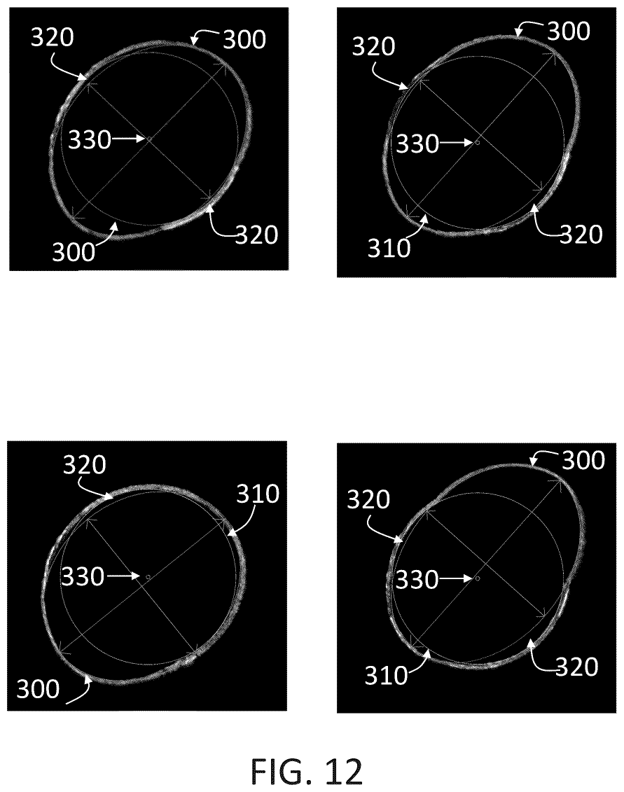

In an embodiment, when the geometry of the imaged part is generally circular, the normal direction will generally correspond to the scanlines of the ultrasound data, which in turn corresponds to a radius of a circular model, as illustrated in FIGS. 9B and 9C. In this embodiment, the first model corresponds to a circle 200 with nominal radius 202 (rₙₒₘᵢₙₐₗ), the reference location 204 corresponds to the circle center X_{c}, and the second model 206 corresponds to a spline, with distance 208 (r_{surface}) from the circle center. A plurality of candidate locations 210 are determined. Wall loss or gain is estimated as the difference between the distance from the estimated center of the circle and the first surface calculated from the first model, corresponding to rₙₒₘᵢₙₐₗ, and the distance r_{surface} to the circle center, calculated from the second model. The estimated thickness deviation is scaled by the inverse of the nominal thickness of the tubular, to denote the wall loss or wall gain as a percentage of the thickness of the part. FIG. 9B illustrates the embodiment where the first surface corresponds to the inner diameter, or ID, of a tubular. FIG. 9C illustrates the embodiment where the first surface corresponds to the outer diameter, or OD, of a tubular. FIG. 10 shows an exemplary ultrasound frame of an inner diameter surface of a tubular, showing the estimated location of the first surface according to the estimated parameters of a first model or circle 200, and the estimated location of the first surface according to the estimated parameters of an instance of a second, spline model 206.

In a further embodiment, a line is used as the first model to describe a generally flat geometry for a first surface of a target, and a spline function is used as the second model to describe the local surface of the target. The normal direction is determined as the direction perpendicular to the line of the first model. A reference location is established as an arbitrary distance in the normal direction from the fitted line corresponding to the first model. In an embodiment, the reference location corresponds to the standoff distance. In an embodiment, a line is used as the third model to describe a generally flat geometry for the second surface, and the normal direction is calculated as a combination of the perpendicular direction to the first model and a perpendicular direction to the second model, such as the average normal over multiple scanlines. The thickness deviation factor for each scanline is calculated as described, above.

In another embodiment of the system, the device and method can be used to estimate the wall loss of a tubular which has been milled internally to alleviate a restriction within the tubular. Milling a wellbore is a routine and critical procedure employed under various conditions to maintain and optimize well performance. Typical applications of milling include the removal of obstructions such as debris and stuck tools; the repair of casing and tubing by excising corroded or mechanically compromised sections; and the creation of exit points essential for sidetracking operations aimed at bypassing problematic zones or accessing untapped reservoirs. Milling is also utilized to form slots or pockets for setting whipstocks, which are necessary for wellbore deviation or re-entry. Additionally, milling facilitates plug and abandon (P&A) operations by removing tubulars and creating appropriate spaces for cement plugs, ensuring secure abandonment of the well. It is further employed in wellbore cleanouts to eliminate scale, paraffin, and other deposits that may restrict flow, and in fishing operations to retrieve or remove stuck or lost tools. Moreover, milling can enlarge the wellbore to accommodate larger casing or enhance production capabilities.

For example, a restriction within the tubular which requires milling can be due to a tubular that has undergone significant deformation. In such a situation, the cross section of a tubular or casing, which would otherwise have a generally circular cross-section, is deformed and becomes ovalized, for example due to external forces or to the formation. Such deformations may negatively affect the fluid flow within a tubular and limit the ability of tools to travel therethrough. A restriction in a tubular may also be due to an object or debris becoming lodged in the borehole, and referred to as a fish, impeding the drilling process or completion operations. A fish can include a variety of items such as a broken drill bit, pieces of the drill string, lost tools, or other foreign objects that have fallen into the wellbore. The presence of a fish can significantly disrupt operations, requiring specialized fishing tools and techniques to retrieve the obstructive item and restore the well to its intended functional state. Efficient fish removal is critical to maintaining the progress and safety of the drilling operation.

To alleviate a restriction, the interior of the tubular is milled out to restore a circular cross section so tools may travel through the tubular unimpeded, and wall loss may occur as a result of the milling. The remaining wall thickness of the tubular is not directly obvious from a radial measurement of the location of the first surface or inner diameter, ID. In this embodiment, one or more locally deformed sections corresponding to a first surface of the target and one or more non-deformed sections corresponding to a first surface of the target are determined. Ultrasound data from one or more locally deformed portions of a first surface is used to determine the parameters of a first global model, to describe a first surface of the target, for example, corresponding to the inner diameter of the tubular. Subsequently, ultrasound data from one or more generally non-deformed portions of the first surface is then used to determine the parameters of a second global model, to describe another portion of the first surface of the target, corresponding, for example, to the inner diameter.

In an embodiment, the one or more locally deformed sections and the one or more non-deformed sections, corresponding to a first surface of the target, are determined based on user input, for example, from user selecting all ultrasound data corresponding to the one or more locally deformed sections and/or selecting all ultrasound data corresponding to the one or more non-deformed sections. In an embodiment, at least one point on each of the one or more locally deformed sections and/or at least one point on each of the one or more non-deformed sections is selected from user input, and an appropriate region growing algorithm is used to determine each of the locally deformed and non-deformed sections. In an embodiment, the one or more locally deformed sections and/or selects at least one point on each of the one or more non-deformed sections are determined using sensor measurements. In embodiments, the one or more locally deformed sections and/or selects at least one point on each of the one or more non-deformed sections are determined using a machine learning algorithm.

In an embodiment, the normal direction of the non-deformed portion of the first surface is determined. In an embodiment, the first model is an ellipse, the second model is a circle, and the normal direction corresponds to the radial direction from the center of the circle to the non-deformed inner diameter. FIG. 12 shows exemplary cases of deformed cross sections of tubulars which have been milled out for portions of the interior surfaces. In these figures first ellipse models 300 and second circle models 310 are shown fitted to the exemplary data.

Wall loss is calculated for regions where the fitted second model is farther than the fitted first model, with respect to a reference location, such as the circle center. Regions 320 in FIG. 12 illustrates where the fitted circle model 310 is farther from the circle center 330 than the fitted ellipse model 300. Within each region 320, wall loss is calculated as the non-negative difference between the distance from the circle center 330 to the circle 310, and the distance from the circle center 330 to the ellipse model 300. In an embodiment, the wall loss value is divided by the nominal wall thickness, to determine the thickness deviation factor as a percentage. In an embodiment, a maximum wall loss for each Z location can be calculated and displayed to a user.

As the imaging device 10 moves longitudinally along the target or tubular, scanning the target laterally or transversely, a thickness deviation factor map is constructed, to display thickness deviation factor information of a section of a target or tubular to a user. In one embodiment, a two-dimensional map showing a thickness deviation factor along a transverse (Θ) dimension is mapped to a first dimension, while thickness deviation factor information along the longitudinal (z) direction is mapped to a second dimension. In one embodiment, the thickness deviation factor map is displayed as a two-dimensional image. In another embodiment, the thickness deviation factor map is mapped as texture to a three-dimensional model of the imaged target. In yet another embodiment, the thickness deviation factor map is used to generate a point cloud representation of the target.

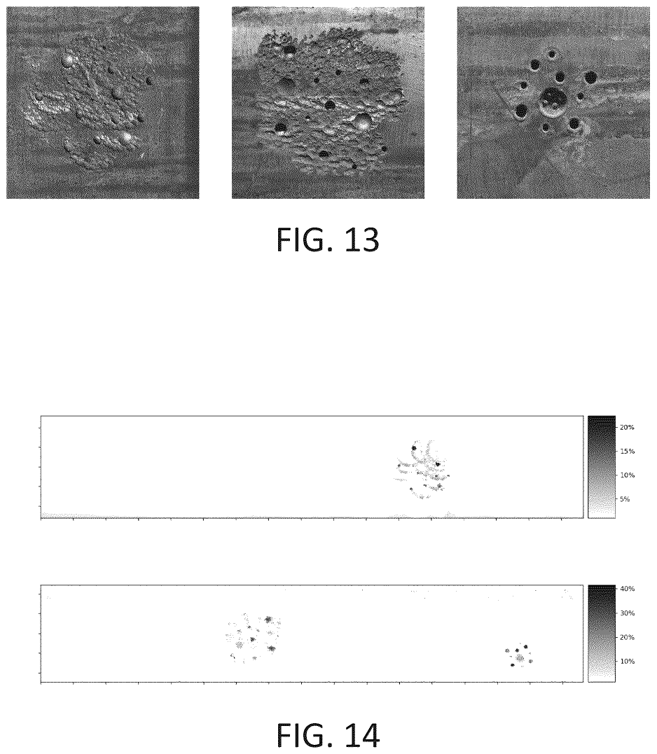

FIG. 13 shows photographs of surfaces of various sample targets, showing flaws representative of those which would typically be encountered in the field. The samples featured a diverse array of flaws, including weld and non-weld cracks, internal (ID) and external (OD) corrosion, and pitting on the OD. FIG. 13 (left) is a photograph of an internal surface of a target, and FIG. 13 (center and right) are photographs of an external surface of a target. The samples were scanned according to the methods disclosed herein, and thickness deviation maps were generated. FIG. 14 (upper) illustrates a thickness deviation map for an inner surface of the target shown in FIG. 13 (left), and FIG. 14 (lower) illustrates a thickness deviation map for an outer surface of the target shown in FIG. 13 (center and right), where brightness is mapped to thickness deviation or wall loss as a percentage, the horizontal axis corresponds to a longitudinal scanning direction, the vertical axis corresponds to a lateral or radial scanning direction. The detected flaws on the external surface are shown to be inverted in the thickness deviation map.

In embodiments, a digital representation of an imaged target is generated. A digital representation, such as a three-dimensional model of the imaged target is constructed using the detected parameters for the first model and the second model. In embodiments, a tubular model is constructed by generating three-dimensional coordinates using one or more radii for a circle model, detected for one or more image frames. The three-dimensional coordinates are further refined based on detected parameters for a spline model. In embodiments, a radial distance between a circle model and a corresponding point on a spline for a corresponding radial direction is determined, to further refine the three-dimensional model. In alternative embodiments, a radial thickness deviation map is mapped to a tubular model surface, the radial thickness deviation map is converted to distance values, for example, by multiplying the radial thickness deviation values by a nominal target thickness, and the three-dimensional model is further refined by displacing the surface of the three-dimensional based on the converted distance values. In embodiments, a three-dimensional model comprises a point cloud. In embodiments, a three-dimensional model comprises a tessellated surface model. By storing detected parameters for a first model and for a second model, a representation of a surface of a target can be stored, without the need to store multiple image frames.

Regions of a thickness deviation factor map of a target with nominal wall thickness will have a constant value. Regions of a thickness deviation factor map with gradually changing values may represent a large-scale deviation of the target or tubular, such as, for example, ovality of a tubular due to physical deformation. Regions of a thickness deviation factor map with rapidly changing values may represent corrosion or a localized deformation. Generally, a thickness deviation factor map will be an accurate representation of localized corrosion or deformation of a region of a target.

The quantification of wall loss is important to determine the structural integrity of a tubular or pipeline, such as by calculating the burst pressure a wellbore tubular or pipeline, which depends on accurate values of wall thickness. If the material is assumed to be homogeneous and isotropic, and the stress distribution is uniform, burst pressure is calculated using Barlow's formula, given by P=(2*S*t)/D, where P is the burst pressure, S is the material's yield strength, t is the wall thickness of the tubular or pipeline, and D is the outer diameter. A conservative calculation of burst pressure can be obtained using the River Bottom Method, to account for potential defects such as corrosion or wall thinning, which modifies Barlow's standard formula by incorporating a correction factor to account for these imperfections by using the effective wall thickness, which reduces wall thickness by the depth of the deepest defect or corrosion pit. Finite element analysis can also be used to calculate burst pressure, where a detailed geometric model of the wellbore tubular or pipeline is generated, which is then discretized into a finite element mesh consisting of numerous small, interconnected elements. Accurate values for wall thickness are critical for obtaining accurate simulated results, especially in cases involving complex geometries, material inhomogeneities, or localized defects. Determining burst pressure is critically important as it ensures the structural integrity and safety of the wellbore tubular or pipeline under operational pressures, especially in environments where corrosion and other forms of degradation are prevalent. Accurate burst pressure calculations help prevent catastrophic failures, environmental hazards, and costly downtimes by ensuring that the materials and design specifications can withstand the maximum internal pressures they will encounter during their service life.

While the current disclosure describes embodiments for fitting two-dimensional ultrasound data to two-dimensional models, it should be apparent to those of skill in the art that the methods and imaging tools can be applied to three-dimensional data and three-dimensional models without departing from the scope of the disclosure.

Terms such as “top”, “bottom”, “distal”, “proximate” “downhole”, “uphole”, “below,” “above,” “upper, downstream,” are used herein for simplicity in describing relative positioning of elements of the conduit or device, as depicted in the drawings or with reference to the surface datum. Although the present methods, systems and devices have been described and illustrated with respect to preferred embodiments and preferred uses thereof, it is not to be so limited since modifications and changes can be made therein which are within the full, intended scope as understood by those skilled in the art.

While many specific details have been provided for a thorough and complete understanding of the embodiments as described herein, it will be understood by those of ordinary skill in the art that said embodiments can be practiced even without these specific details. In other instances, detailed descriptions of components, methods and procedures have not been provided to avoid obscuring the relevant features being described. Further, the embodiments described herein should not be considered as limiting the scope of the method, system and devices as recited in the claims.

1. A method of inspecting a surface of a target comprising:
deploying an ultrasound imaging device comprising at least one phased array ultrasonic transducer to obtain ultrasound data from a target surface;
defining a first region of the ultrasound data based on an estimated location of the target surface within a tolerance of 10% to 90% of a nominal target thickness, in a direction normal to the target surface;
identifying a plurality of target surface candidate locations from the ultrasound data within the first region;
determining parameter values for a first global shape model defining the target surface from the plurality of target surface candidate locations;
determining parameter values for a second shape model defining the target surface from the plurality of target surface candidate locations;
generating a thickness deviation factor from a difference between a surface defined by the first global shape model parameter values and a surface defined by the second shape model parameter values, along a direction normal to the surface defined by the first global shape model parameter values;
generating a thickness deviation map for the target surface using a plurality of thickness deviation factors; and
identifying a flaw based on the thickness deviation map.

2. The method according to claim 1, wherein the thickness deviation factor defines a wall loss of the target surface.

3. The method according to claim 1, wherein generating a thickness deviation factor further comprises generating the thickness deviation factor as a percentage of the nominal target thickness.

4. The method according to claim 1, wherein the first global shape model defines a circle.

5. The method according to claim 1, wherein the first global shape model defines an ellipse.

6. The method according to claim 2, wherein the second shape model defines a spline function.

7. The method according to claim 4 further comprising:
defining a first subset of candidate locations from the plurality of target surface candidate locations corresponding to one or more first portions of the target surface; and
defining a second subset of candidate locations from the plurality of target surface candidate locations corresponding to one or more second portions of the target surface;
wherein determining parameter values for the first global shape model further comprises using the first subset of candidate locations;
wherein the second shape model is a second global shape model and defines a circle, and wherein determining parameter values for the second global shape model further comprises using the second subset of candidate locations; and
wherein generating a thickness deviation factor further comprises determining a non-negative difference between the surface determined by the second global shape model and the surface determined by the first global shape model, along directions normal to the surface determined by the first global shape model.

8. The method according to claim 1, wherein identifying a plurality of target surface candidate locations further comprises identifying maximum intensity locations from the ultrasound data, greater than a predetermined threshold.

9. The method according to claim 1, further comprising:
defining one or more subsets of adjacent candidate locations from the plurality of target surface candidate locations, each of the one or more subsets of adjacent candidate locations corresponding to local sections of the surface of the target; and
wherein the second shape model is a second local shape model and defines a spline function, and wherein determining parameter values for the second local shape model further comprises determining parameter values for the second local shape model for each of the one or more subsets of adjacent candidate locations.

10. The method according to claim 9, wherein the one or more subsets of adjacent candidate locations are padded with values representing an estimated surface location.

11. The method according to claim 9, wherein each of the one or more subsets of adjacent candidate locations is obtained from ultrasound data from one of a plurality of phased array ultrasonic transducers.

12. The method according to claim 1, wherein determining the plurality of target surface candidate locations further comprises receiving user input setting one or more of the plurality of target surface candidate locations.

13. The method according to claim 1, wherein determining the plurality of target surface candidate locations further comprises receiving user input modifying one or more of the plurality of target surface candidate locations.

14. The method according to claim 1, further comprising:
defining a second region of the ultrasound data based on an estimated location of a second target surface within a tolerance of 10% to 90% of an estimated target thickness in a direction normal to the second target surface;
identifying a plurality of candidate locations for the second target surface from the ultrasound data, within the second region;
determining parameter values for a third global shape model defining the second target surface from the plurality of candidate locations for the second target surface; and
determining a measured target thickness from distances between the surface defined by the first global model and a surface defined by the third global model, along directions normal to the surface determined by the first global shape model;
wherein generating a thickness deviation factor further comprises generating the thickness deviation factor as a percentage of the measured target thickness.

15. The method according to claim 1, further comprising generating a digital representation of the target using the thickness deviation map and storing the digital representation of the target.

16. The method according to claim 15, wherein generating a digital representation of the target further comprises generating a geometry of the target using the parameter values for a first global shape model and the parameter values for a second shape model.

17. A system for inspecting a surface of a target comprising:
A device with elongate body deployable in a cylindrical fluid conduit, comprising one or more outward-facing phased array ultrasonic transducers for emitting plane waves and receiving ultrasound data;
at least one processor; and
a computer-readable medium storing instructions that, when executed by the at least one processor, cause it to perform the method of claim 1.

18. The system according to claim 17, wherein the one or more outward-facing phased array ultrasonic transducers further comprise one or more radial arrays.

19. The system according to claim 17, wherein the device further comprises a plurality of phased array ultrasonic transducers.

20. The system according to claim 17, wherein the at least one processor further comprises at least one cloud processor.
